(19) United States
(12) Patent Application Publication
(10) Pub. No.: US 2014/0332129 A1
(43) Pub. Date: Nov. 13, 2014

(54) RUN-FLAT TIRE

(71) Applicant: HSIANG-TING CHEN, KAOHSIUNG CITY (TW)

(72) Inventor: LI-DA CHEN, KAOHSIUNG CITY (TW)

(73) Assignee: HSIANG-TING CHEN, KAOHSIUNG CITY (TW)

(21) Appl. No.: 13/890,079

(22) Filed: May 8, 2013

(51) Int. Cl. B60C 17/06

(52) U.S. Cl. CPC B60C 17/066; B60C 17/06
USPC 152/158

(57) ABSTRACT

A run-flat tire, comprising a rim, a tire skin, and one or more elastomers, wherein the elastomer(s) is installed in a holding space within the tire skin, wherein the number of elastomers depending on the inner diameter of the tire skin and the inner width; while the external dimension and shape of the elastomer depends on the inner width of the tire skin and the tire width and shape of the tire skin, wherein the diameter of the elastomer shall be close to or no more than the inner diameter top of the tire skin and the inner diameter bottom of rim center.

### SUMMARY OF INVENTION

### Chinese

A kind of run-flat tire, consists of the rim, tire skin, and elastomer, whose characters are: in the holding space inside the tire skin, there place several elastomers, and the number of elastomers depends on the inside diameter in the tire skin and the inner width; while the external dimension and shape of the elastomer depend on the inner width of the tire skin and the tire width and shape of the tire skin. Therefore, the diameter of the elastomer shall be close to or no more than the inner diameter top of the tire skin and the inner diameter bottom of rim center.

### FIGURES

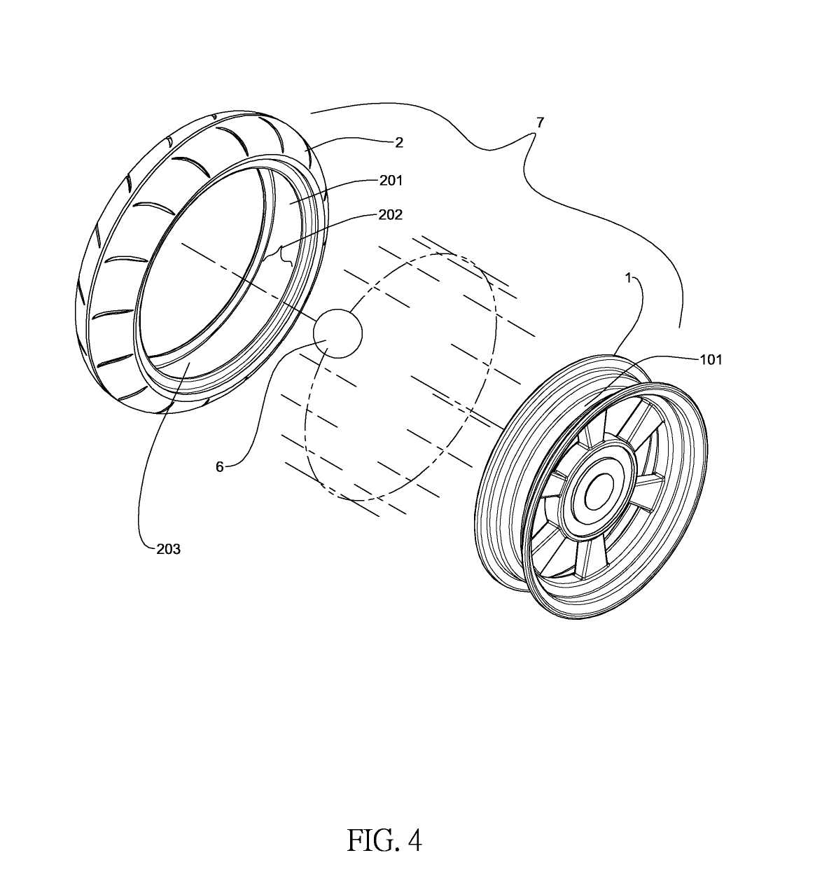

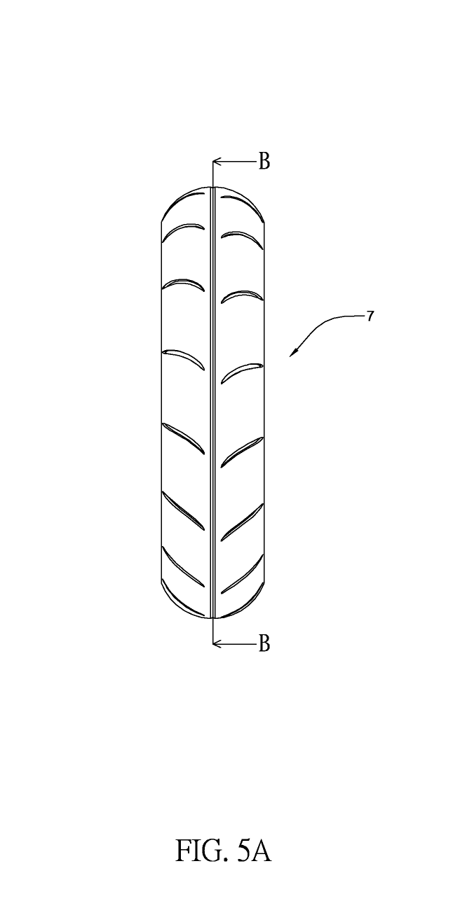

Appointed Figure of This Case: FIG. 4).

Symbol Description of Figure:

| | | |
|---|---|---|
| 1 | Rim | 101 Inner diameter bottom |
| 2 | Tire skin | 201 Holding space |
| 202 | Inner width | 203 Inner diameter top |
| 6 | Elastomer | 7 Run-flat tire |

### FIELD OF TECHNOLOGY

This invention is to provide a structure appliance of the run-flat tire, especially an appliance not needing to change the current tire structure, which means any existing tire structure could be improved to the tire structure with run-flat character through the place of this structure appliance.

### PRIOR TECHNOLOGY

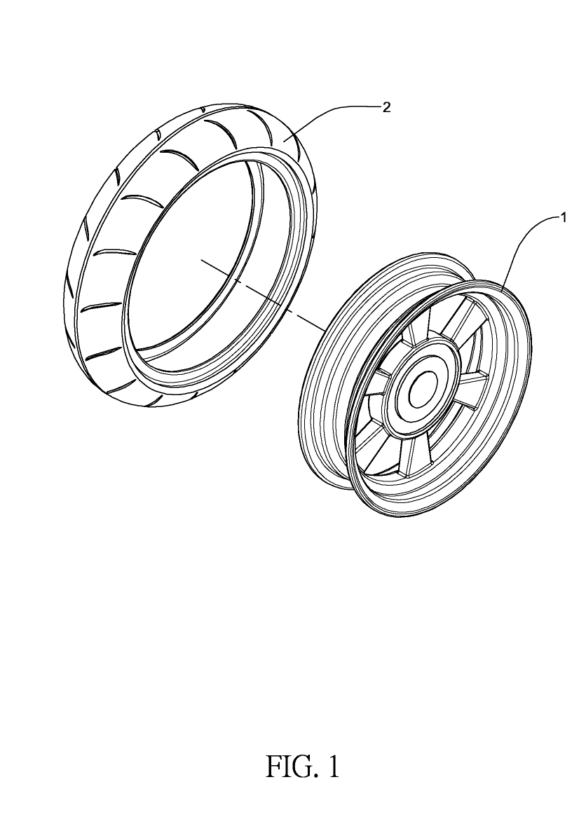

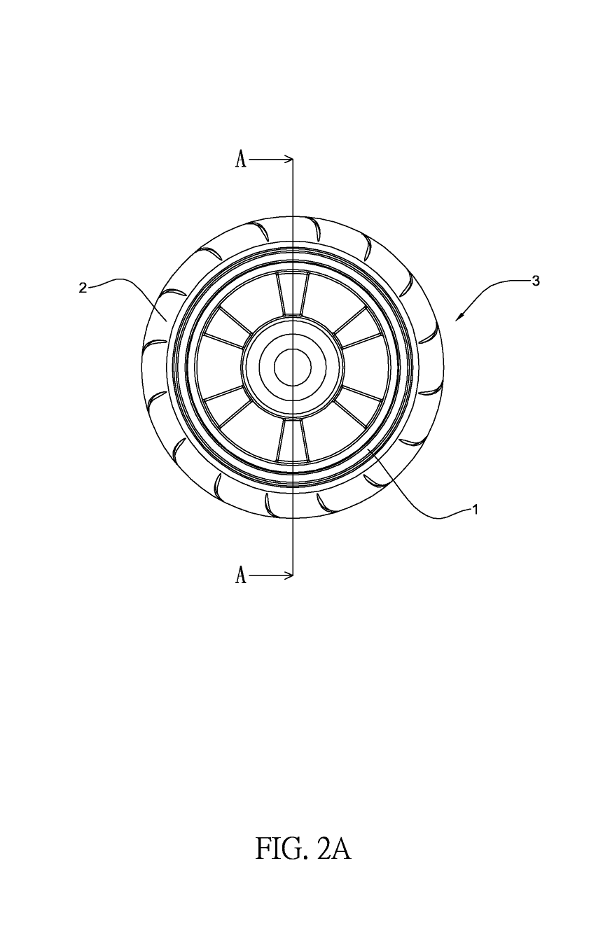

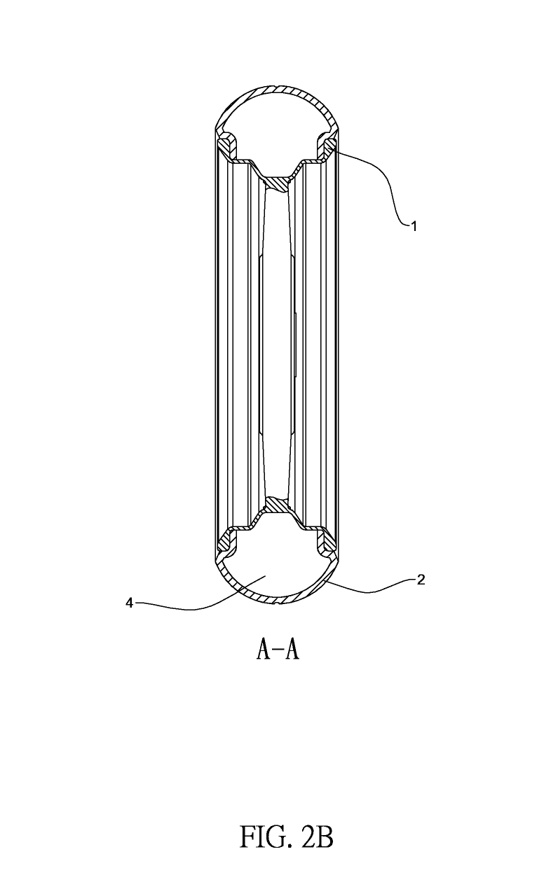

Please refer to FIG. 1, FIG. 2A and FIG. 2B. Generally, no matter the customer uses the motorcycle or automobile, the structure of the tire 3 is building-in of the tire skin 2 on the rim 1, to make it in one, and emptying the space between the tire skin 2 and the rim 1 to be the holding space 4, to allow the expansion of the tire skin 2, forming the pattern shown in FIG. 2B. And such structure of the tire 3 could bear the load and roll. However, this structure has the following shortcomings in the operation:

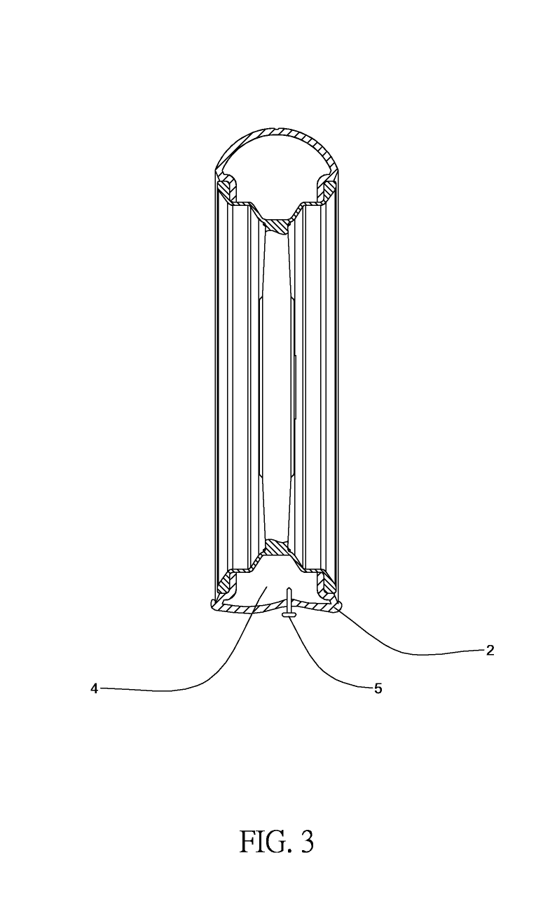

1 • Please refer to FIG. 3 again. As the structure of the tire 3 is just to expand by filling air, after the tire 3 is punctured by the nail 5, the air in the holding space 4 would leak the air from the tear promptly, and cause the tire skin 2 being flat, which shall make the motorcycle or automobile equipped the tire cannot run, even cause danger for the driving.

2 • When the driver encounters the air leakage situation of the tire 3, as the tire skin 2 has been flat, if there is no maintenance station nearby for repair, the driver could not push the flat-tire vehicle, which brings the difficulty for the assistance.

3. When there comes the air leakage of the tire of the motorcycle or automobile, it needs to be forced to push to the maintenance station for repair, which shall make the lat tire skin 2 chapped or broken for the forced rolling, and make the tire 3 cannot be repaired but replaced, to increase the maintenance expense.

### CONTENT OF INVENTION

As there are the above said disadvantages in the currently used structure, against which this invention is, I tried everything and combined the years experience to make this invention, to solve the existing shortcomings and improve the advancement and practicality. The technological means of this invention to solve the difficulties are as below:

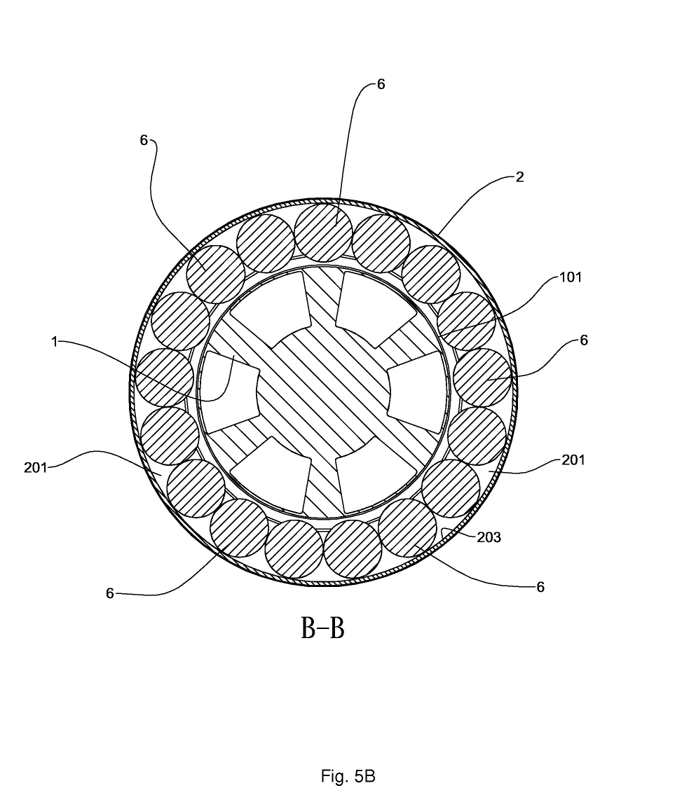

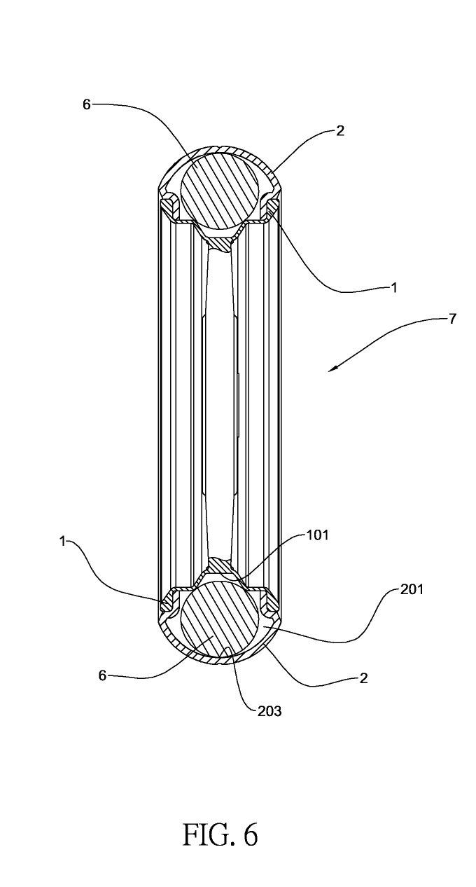

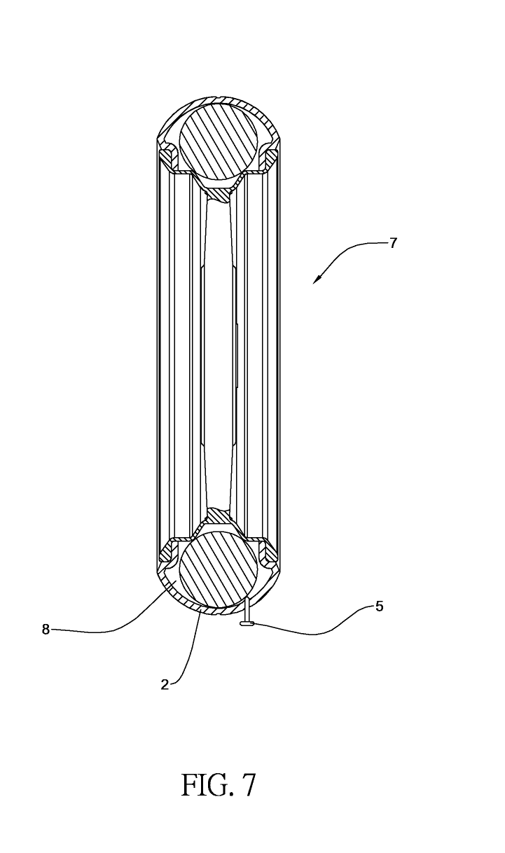

1 • Please refer to FIG. 4, FIG. 5A and FIG. 5B. As this invention is located in the holding space 201 in the tire skin 2, by placing several round elastomers 6. After air inflation, there are several connected elastomers 6 in the holding space 201 between the tire skin 2 and the rim 1, as shown in FIG. 5B. Therefore (Please refer to FIG. 6 and FIG. 7), when the tire skin 2 is punctured by the nail 5, and the air leaks from the tear on the tire skin 2, the elastomer 6 shall support between the tire skin 2 and the rim 1, to provide supporting for the air leaked tire and avoid the tire skin 2 being flat, as well as keeping running, which solves the existing disadvantages.

2 • Please refer to FIG. 5B and FIG. 7. When the invented run-flat tire 7 is punctured by the nail 5, for the supporting of the elastomer 6 in the tire skin 2, the punctured tire skin 2 shall not be flat, but keep the status the same as before punctured, to keep the driving of vehicle till the maintenance station without difficulty, in which way it solves the existing shortcomings.

3 • Please refer to FIG. 5B and FIG. 7. As there are several elastomers 6 in the tire skin 2, when the tire skin 2 is punctured, the tire skin 2 shall not be flat for the air leakage, but keep the status the same as before punctured, to keep the driving of vehicle till the maintenance station without chap or break, in which way it solves the existing shortcomings.

The major purpose of this invention is to provide a run-flat tire structure, without change of the current tire structure, to make the ordinary tire improved to the run-flat tire by adding the elastomer of this invention.

The secondary purpose of this invention is to provide a run-flat tire structure, in which the number of the elastomer placed in the holding space in the tire skin depends on the inside diameter and inner width of the tire skin.

The minor purpose of this invention is to provide a run-flat tire structure, in which the size and shape of the elastomer placed in the holding space in the tire skin depends on the inner width and shape of the tire skin.

### FIGURE DESCRIPTION

FIG. 1: Stereoscopically Exploded Schematic Diagram of Currently-used Tire.

FIG. 2A: Side-looking Schematic Diagram of Currently-used Assembly.

FIG. 2B: Section Schematic Diagram of FIG. 2A.

FIG. 3: Schematic Diagram of Currently-used Tire Punctured by Nail.

FIG. 4: Stereoscopically Exploded Schematic Diagram of This Invention.

FIG. 5A: Schematic Diagram of Assembly of This Invention.

FIG. 5B: Section Schematic Diagram of FIG. 5A.

FIG. 6: Section Schematic Diagram of FIG. 5B.

FIG. 7: Schematic Diagram of Run-Flat Tire Punctured by Nail.

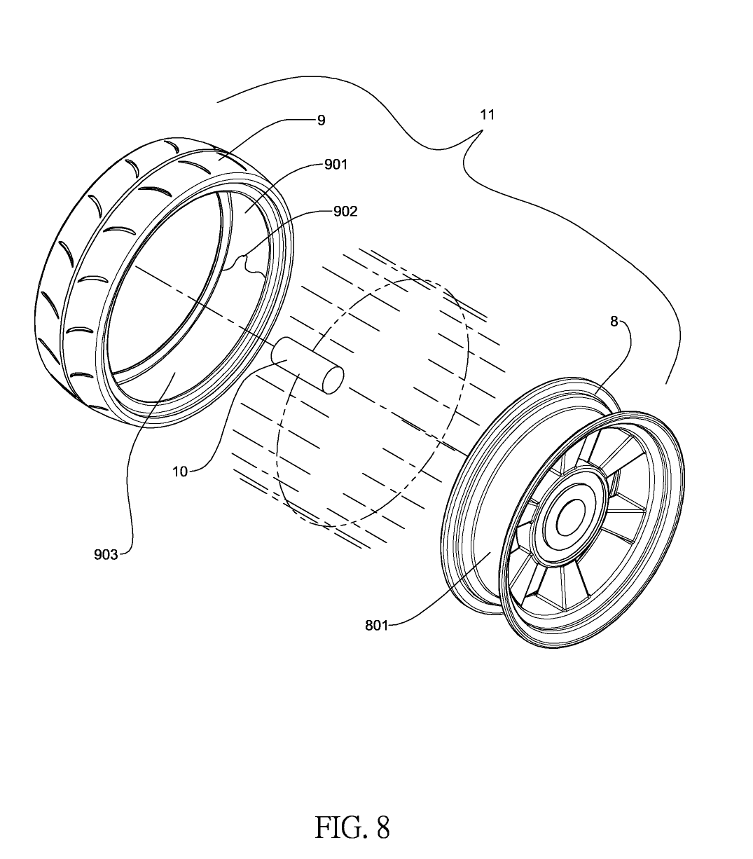

FIG. 8: Stereoscopically Exploded Schematic Diagram of Another Executed Case of This Invention.

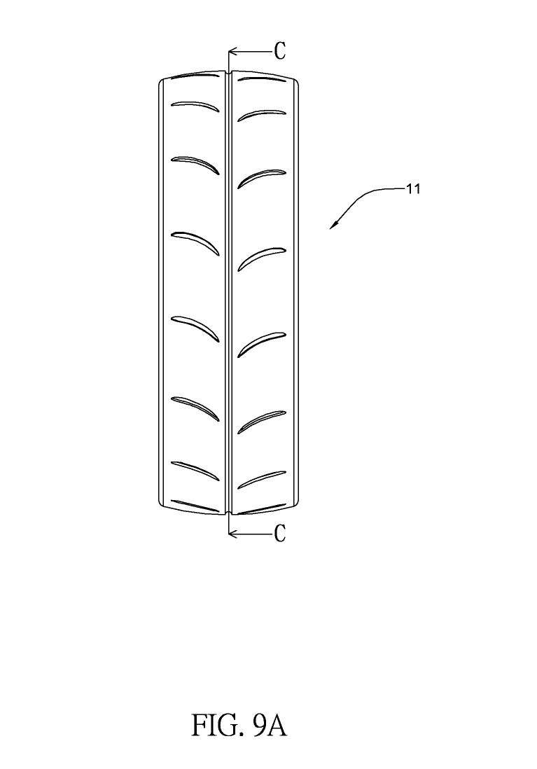

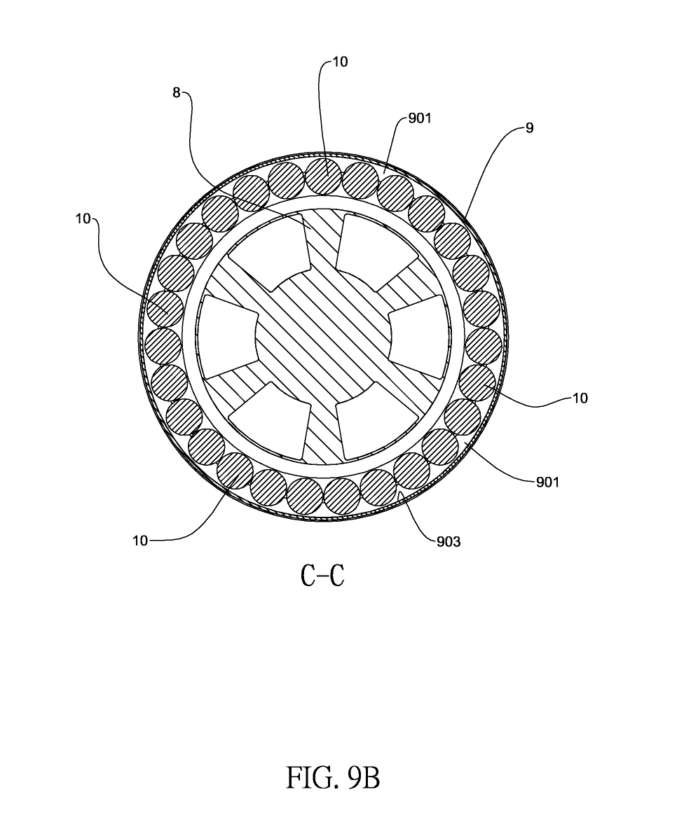

FIG. 9A: Schematic Diagram of Assembly of This Invention.

FIG. 9B: Section Schematic Diagram of FIG. 9A.

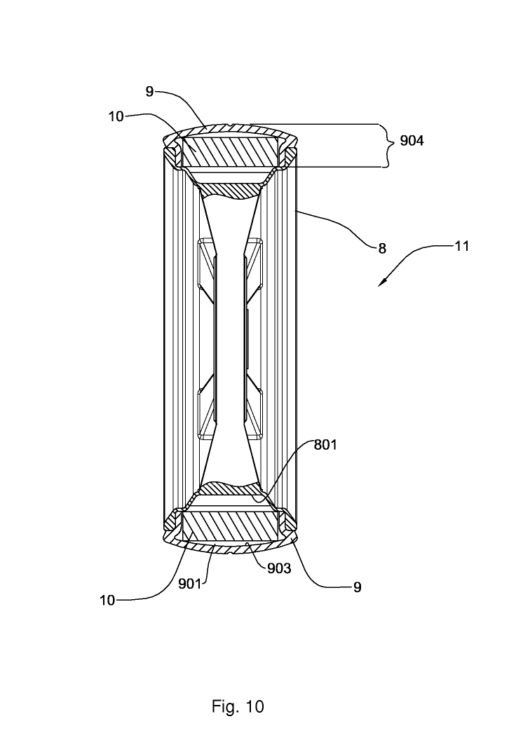

FIG. 10: Section Schematic Diagram of FIG. 9B.

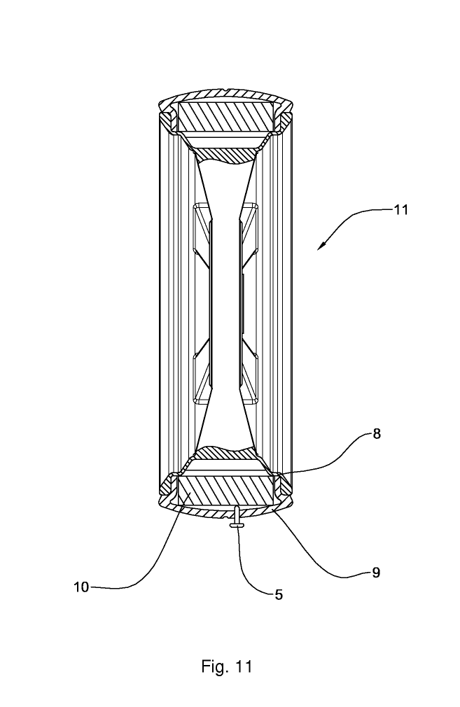

FIG. 11: Schematic Diagram Run-Flat Tire Punctured by Nail of Another Executed Case of This Invention.

### MODE OF EXECUTION

In order to better describe the purpose, function and structure characters of this invention, I hereby give the good executed cases and the diagram illustration as below. Please refer to FIG. 4, FIG. 5A and FIG. 5B. This invention is to provide a run-flat tire, consisting of the rim 1, tire skin 2, and elastomer 6. In which, the shape and size of the elastomer 6 depends on the inner width 202 and the shape of the tire skin 2, namely when the inner width 202 is large, the size of elastomer 6 is large, conversely is small. And when the tread shape of the common tire skin 2 is the circular arc, the shape of the elastomer 6 is the round; on the contrary, if the tread shape of the tire skin 2 is flat, the shape of the elastomer 6 is the cylinder. As the tread shape of the tire skin 2 in this invention is the circular arc rather than the flat, the shape of the elastomer 6 is the round rather than the cylinder. When using, it is to place several elastomers 6 in the holding space 201 of the tire skin 2. The number of the elastomer 6 is on the basis of the inside diameter and inner width 202 of the tire skin 2, namely when the inner width 202 of the tire skin 2 is large, the size of the elastomer 6 is large; on the contrary, the size of the elastomer 6 is small. Therefore, after ensuring the size of the elastomer 6 according to the size of the inner width 202 of tire skin 2, and the inside diameter of the tire skin 2, the number of the elastomer 6 shall be determined, in which way the diameter of the elastomer 6 could be close to or up to the place of the inner diameter top 203 of tire skin 2 and the center inner diameter bottom 101 of the rim 1, as shown in FIG. 6. And after placing several elastomers 6 in the holding space 201 of the tire skin 2, there shall form a connected but separated round solid in the holding space 201, as shown in FIG. 5B.

Please refer to FIG. 6 and FIG. 7. When the tire skin 2 is punctured by the nail 5, and the air leaks from the tear on the tire skin 2, the elastomer 6 shall support between the tire skin 2 and the rim 1, to provide supporting for the air leaked run-flat tire 7 and avoid the tire skin 2 being flat, prevent the driving danger caused by the puncture of the nail 5, and keep running to allow the driver finding a nearby maintenance station and increase the convenience and safety of the user.

Please refer to FIG. 8, FIG. 9A and FIG. 9B. This invention is to provide a run-flat tire, consisting of the rim 8, wide tire skin 9, and cylindrical elastomer 10. In which, as the shape and size of the tire skin is flat, the shape and size of the cylindrical elastomer 10 shall depend on the inner width 902 of the wide tire skin 9 and the thickness 904 (namely the flatness ratio) of the wide tire skin 9; namely when the inner width 902 is large, the length of the cylindrical elastomer 10 is large, conversely is small; when the thickness 904 (namely the flatness ratio) is small, the diameter of the cylindrical elastomer 10 is small, conversely is large. When the tread shape of the common tire skin is the circular arc, the shape of the elastomer is the round; on the contrary, if the tread shape of the tire skin 2 is flat, the shape of the elastomer 6 is the cylinder. As the tread shape of the tire skin 9 in another executed case of this invention is flat rather than the common circular arc, the shape of the cylindrical elastomer 10 is the cylinder rather than the round. When using, it is to place several cylindrical elastomers 10 in the holding space 901 of the tire skin 9. The number of the cylindrical elastomer 10 is on the basis of the inside diameter and thickness 904 (namely the flatness ratio) of the wide tire skin 9, namely when the thickness 904 (namely the flatness ratio) of the tire skin 2 is large, the size (refer to the diameter) of the cylindrical elastomer 10 is large; on the contrary, the size of the cylindrical elastomer 10 is small. Therefore, after ensuring the size of the cylindrical elastomer 10 according to the thickness 904 (namely the flatness ratio) of the tire skin 2, and the inside diameter of the tire skin 2, the number of the cylindrical elastomer 10 shall be determined, in which way the diameter of the cylindrical elastomer 10 is close to or up to the position of the inner diameter top 903 of the wide tire skin 9 and the center inner diameter bottom 801 of the rim 8, as shown in the FIG. 10. And after placing several cylindrical elastomers 10 in the holding space 901 of the tire skin 9, there shall form a connected but separated cylindrical solid in the holding space 901, as shown in FIG. 9B.

Please refer to FIG. 10 and FIG. 11. When the run-flat tire 11 is punctured by the nail 5, and the air leaks from the tear on the tire skin 9, the cylindrical elastomer 10 shall support between the wide tire skin 9 and the rim 8, to provide supporting for the air leaked run-flat tire 11 and avoid the wide tire skin 9 being flat, prevent the driving danger caused by the puncture of the nail 5, and keep running to allow the driver finding a nearby maintenance station and increase the convenience and safety of the user.

To sum up, this run-flat tire invention is designed elaborately and diligently, which is practical, simple in structure and using, easy and fast in assembly, and low in cost, satisfying the requirement of the Patent for Invention of Patent Law. It is applied in accordance with the law, waiting for the penetrating judgment and approval of the examiner. Thank you.

The above mentioned is just the good executed cases of this invention, to which the patent scope of this invention shall not be limited. The equivalent structure change as the Invention Instruction and Application Patent Scope shall be included in the scope of this invention and stated clearly.

Symbol Description

| | | |
|---|---|---|
| 1 | Rim | 101 Inner diameter bottom |
| 2 | Tire skin | 201 Holding space |
| 202 | Inner width | 203 Inner diameter top |
| 3 | Tire | |
| 4 | Holding space | |
| 5 | Nail | |
| 6 | Elastomer | |
| 7 | Run-flat tire | |
| 8 | Rim | 801 Inner diameter bottom |
| 9 | Wide tire skin | 901 Holding space |
| 902 | Inner width | 903 Inner diameter top |
| 904 | Thickness | |
| 10 | Cylindrical elastomer | |
| 11 | Run-flat tire | |

### Application Patent Scope

1. A kind of run-flat tire, consists of the rim, tire skin, and elastomer, and the elastomer is installed in the holding space within the tire skin, whose characters are: in the holding space inside the tire skin, there place several elastomers, and the number of elastomers depends on the inside diameter in the tire skin and the inner width; while the external dimension and shape of the elastomer depend on the inner width of the tire skin and the tire width and shape of the tire skin. Therefore, the diameter of the elastomer shall be close to or no more than the inner diameter top of the tire skin and the inner diameter bottom of rim center.
2. A kind of run-flat tire, consists of the rim, tire skin, and cylindrical elastomer, and the cylindrical elastomer is installed in the holding space within the tire skin, whose characters are: in the holding space inside the tire skin, there place several cylindrical elastomers, and the number of cylindrical elastomers depends on the inside diameter in the tire skin and the thickness of the wide tire skin (namely the flatness ratio); while the external dimension and shape of the cylindrical elastomer depend on the inner width of the wide tire skin and the thickness (namely the flatness ratio) of the wide tire skin. Therefore, the diameter of the cylindrical elastomer shall be close to or no more than the inner diameter top of the tire skin and the inner diameter bottom of rim center.
3. If applying the run-flat tire described in Item 1 or Item 2, when the tread of the tire skin is the circular arc, the shape of the elastomer shall be circle, and when the tread of the tire skin is the wide circular arc, the shape of the elastomer shall be cylinder.

1. A run-flat tire comprising a rim, a tire skin, and one or more elastomers, wherein the elastomer(s) is installed in a holding space within the tire skin, wherein the number of elastomers depending on the inner diameter of the tire skin and the inner width; while the external dimension and shape of the elastomer depends on the inner width of the tire skin and the tire width and shape of the tire skin, wherein the diameter of the elastomer shall be close to or no more than the inner diameter top of the tire skin and the inner diameter bottom of rim center.

2. A run-flat tire comprising a rim, a tire skin, and a cylindrical elastomer, and the cylindrical elastomer is installed in a holding space within the tire skin, wherein the holding space inside the tire skin, has one or more cylindrical elastomers, the number of cylindrical elastomers depending on the inside diameter in the tire skin and the thickness of the wide tire skin (namely the flatness ratio); while the external dimension and shape of the cylindrical elastomer depends on the inner width of the wide tire skin and the thickness (namely the flatness ratio) of the wide tire skin, wherein the diameter of the cylindrical elastomer shall be close to or no more than the inner diameter top of the tire skin and the inner diameter bottom of rim center.

3. The run-flat tire of claim 1 wherein the tread of the tire skin is a circular arc, the shape of the elastomer is a circle, and wherein the tread of the tire skin is a wide circular arc, and the shape of the elastomer shall be cylinder.

4. The run-flat tire of claim 2 wherein the tread of the tire skin is a circular arc, the shape of the elastomer shall be circle, and wherein the tread of the tire skin is the wide circular arc, the shape of the elastomer shall be cylinder.
